(19) United States
(12) Patent Application Publication
(10) Pub. No.: US 2016/0064106 A1
(43) Pub. Date: Mar. 3, 2016

(54) Residual power of UNF

(71) Applicants: Robert Vrabel, Castkov (SK); Pavol Tanuska, Biely Kostol (SK); Peter Schreiber, Bratislava (SK); Pavel Vazan, Trnava (SK); Michal Kopcek, Trnava (SK)

(72) Inventors: Robert Vrabel, Castkov (SK); Pavol Tanuska, Biely Kostol (SK); Peter Schreiber, Bratislava (SK); Pavel Vazan, Trnava (SK); Michal Kopcek, Trnava (SK)

(21) Appl. No.: 14/474,338

(22) Filed: Sep. 2, 2014

(51) Int. Cl. G21C 17/112

(52) U.S. Cl. CPC G21C 17/112

(57) ABSTRACT

A heat transfer approach to the calculation of residual power of used nuclear fuel (UNF). This application is a conceptual design of an alternative method for determination of residual power of UNF. Our approach is based on the heat transfer analysis of UNF in the transport container with a compact storage cask. To our knowledge, the proposed method for the calculation of residual power of UNF directly in the transport container is unique and can also provide an effective tool to verify the SCALE 6 in order to ensure the safe transport of the UNF.

### CROSS-REFERENCES TO RELATED APPLICATIONS

Not Applicable.

### STATEMENT REGARDING FEDERALLY SPONSORED RESEARCH OR DEVELOPMENT

Not Applicable.

### MICROFICHE APPENDIX

Not Applicable.

### BACKGROUND OF INVENTION

1. Field of Invention

This invention relates to novel alternative methodology to be used for calculation of residual power of used nuclear fuel (UNF) for the safe transport of radioactive material satisfying the safety standards required by International Atomic Energy Agency.

2. Description of Related Art

The current determination of residual power of nuclear fuel is based on the SCALE 6 specialized software packages as a tool for WWER-440 fuel. The computations of residual power are performed by the module ORIGEN-S. ORIGEN-S is widely used in nuclear reactor and processing plant design studies, design studies for used fuel transportation and storage, burnup credit evaluations, decay heat and radiation safety analyses, and environmental assessments.

This module computes the time-dependent concentrations and radiation source terms of a large number of isotopes, which are simultaneously generated or depleted through neutronic transmutation, fission, and radioactive decay. The computations are based on the system of linear differential equations of the first order. The equations describe the creation and the destruction of nuclides in the fuel. The results of computations are the residual power [W], the activity [Bq], the intensity of photons sources [f/s] and the intensity of neutrons sources [n/s] according to the cooling time.

### BRIEF SUMMARY OF INVENTION

Unlike the SCALE 6 system, our approach for the calculation of the residual power of used nuclear fuel is based on the mathematical modeling of heat transfer through the wall of the transport container with the used nuclear fuel inside. More precisely, the proposed methodology is based on measuring the temperature changes of the water in the container (the values T_{ih,water.in,av}) and the outer walls of the container and was applied to the two independent measurements with a real UNF. A direct comparison of the results obtained with the SCALE 6 and a combined analytical/experimental heat transfer modeling show good correspondence of the results.

### BRIEF DESCRIPTION OF THE TABLES

Having thus described the invention in general terms, reference will now be made to the accompanying tables, and wherein:

TAB. 1 contains the values T_{ih,water.in,av}, i=0, . . . , N for first verification experiment.

TAB. 2 contains the values T_{ih,water.in,av}, i=0, . . . , N for second verification experiment.

### DETAILED DESCRIPTION OF THE INVENTION

Three simplifications have to be made, to avoid potential problem with derivation of exact mathematical model:
1) The water temperature T(t) of a homogenized C-30 transport container with basket KZ-48 depends only on the time and is spatially uniform within the container.
2) The residual power of used nuclear fuel P is constant (i.e. dP/dt=0) (Remark. Later, we will improve the mathematical model by an iterative process to enhance the accuracy).
3) The container with compact storage cask KZ-48, nuclear fuel and water is a homogeneous body with specific heat capacity Cₕₒₘ.
   The burned-out fuel in a container radiates energy. The radiated energy is equal to the energy submitted into environment. The analytical computations for thin-walled vessels adapted to our situation by homogenization of the container with its content and using a weighted average show, that the temperature of water inside the container is governed by the differential equation

$$\frac{d T ( t )}{d t} + \frac{S α}{{MC}_{hom}} ( T ( t ) - {T}_{∞} ) = \frac{P}{{MC}_{hom}} \qquad ( 1 )$$

with the initial condition

T(0)=T_{0,water.in,av}. (2)

In the above equations are used the following parameters:
t—the time elapsed from the beginning of measurement i.e. approximate time since placement in the container [s]
Cₕₒₘ—specific heat capacity of the homogenized container C-30 with nuclear fuel basket KZ-48 and nuclear fuel

$$[ \frac{J}{kg ° C .} ]$$

α—heat transfer coefficient for the surface of a container C-30

$$[ \frac{W}{{m}^{2} ° C .} ]$$

S—external surface area of the container C-30 [m²]
T_{0.water.in,av}—average water temperature detected by the three sensors located inside the transport container C-30 at the time t=0 [° C.]
T_{∞}—surroundings temperature of the air which are at a constant (an adjustable air conditioning system was used) [° C.]
M—total mass of the C-30 transport container with the nuclear fuel basket KZ-48 and used nuclear fuel [kg]
P—residual power of used nuclear fuel [W].

The unique solution of the initial value problem (1), (2) is the function

$$T ( t ) = \frac{P}{S α} + {T}_{∞} + ( {T}_{0 , water \cdot in , av} - \frac{P}{S α} - {T}_{∞} ) exp [ - \frac{S α t}{{C}_{hom} M} ] , \\ t ∈ [ 0 , ∞ ) . \qquad ( 3 )$$

Heat is transferred from the water at the higher temperature to the wall of the container with the fins, conducted through the wall, and then finally transferred from the cold side of the wall into the surroundings air at the lower temperature. This series of convective and conductive heat transfer processes is known as overall heat transfer. In practice generally only an average heat transfer coefficient α is required in order to evaluate the heat power from an area S into the fluid (the air).

For the experiments was used the container C-30 with compact basket KZ-48 with used nuclear fuel. Their parameters are:
Container C-30 (made of thick-walled structural steel S355JO (Euronorm))
   Mass: 67300 [kg]
   Specific heat capacity:

$${C}_{C 30} = 425 + 0.773 {T}_{steady , coat \cdot out , av} \\ - 0.00169 {T}_{steady , coat \cdot out , av}^{2} + 0.00000222 {T}_{steady , coat \cdot out , av}^{3} [ \frac{J}{kg ° C .} ]$$

Compact basket KZ-48 (austenitic stainless steel) with hexagonal cases (boron steel) containing 48 used nuclear assemblies
   Mass of basket: 982 [kg]
   Specific heat capacity:

$${C}_{KZ - 48} = 500 [ \frac{J}{kg ° C .} ]$$

Mass of cases: 1968 [kg]
Specific heat capacity:

$${C}_{cases} = 475 [ \frac{J}{kg ° C .} ]$$

A nuclear fuel assembly comprises a sheath, and nuclear material (UO₂ tablets) inside the sheath:
   Cladding material (zirconium alloy)
      Mass: 4014.48 [kg]
      Specific heat capacity:

$${C}_{zircaloy} = 285 [ \frac{J}{kg ° C .} ]$$

used nuclear fuel—inside the fuel assembly is placed 126 fuel rods about 2.5 [m] long which include ceramic tablets of uranium dioxide (UO₂ tablets—˜4.8% of actinides)
   Mass: 6545.52 [kg]
   Specific heat capacity:

$${C}_{fuel} = 132.65 [ \frac{J}{kg ° C .} ]$$

Total mass (KZ-48 plus fuel rods plus cladding material): 13510 [kg]
coolant (water)
   Mass: 3790 [kg]
   Specific heat capacity:

$${C}_{w} \geq 4186 [ \frac{J}{kg ° C .} ]$$

in the dependence on the temperature.
Thus for the homogenized specific heat capacity of the container C-30 with nuclear fuel we have

$${C}_{hom} = \frac{1}{M} [ 67300 {C}_{C 30} + 3790 {C}_{w} + 3438190.03 ] , \\ M = 84600 \qquad ( 4 )$$

where the number

3438190.03=(982×C_{KZ-48})+(1968×C_{cases})+(4014.48×C_{zircaloy})+(6545.52×C_{fuel})=(982×500)+(1968×475)+(4014.48×285)+(6545.52×132.65)

represents a total heat capacity of the basket KZ-48 with the 48 used nuclear assemblies.

For calculating the convection power we obtain, by the limit process for t→∞ in (3),

P=Sα(T(∞)−T_{∞})=Sα(T_{steady,water.in,av}−T_{∞}). (5)

Due to the idea/strategy of homogenization of the system container plus water we use for P the modified relation

P=Sα(T_{steady,hom}−T_{∞}) (6)

where
T_{steady,hom}—mass-weighted steady state temperature of the container, in our case

$$\frac{{T}_{steady , water \cdot in , av} \times 3790 + {T}_{steady , coat \cdot out , av} \times 67300}{3790 + 67300} , \qquad ( 7 )$$

T_{steady,coat.out,av}—average temperature calculated from the temperatures detected by sensors (the total amount of them is 84) situated uniformly on the selected spots on surface of the container at the time when the average temperature reached a steady-state [° C.]
T_{steady,water.in,av}—average water temperature in the center of container measured by the three sensors at the time when the average water temperature reached a steady-state [° C.].
   Here we use the concept mass-weighted average temperature i.e. the mass-weighted average of a quantity is computed by dividing the summation of the product of density ρᵢ, cell volume, and the selected field variable (for instance the temperature Tᵢ) by the summation of the product of density and cell volume |Vᵢ|

$$\frac{{{\sum }_{i = 1}}^{n} {T}_{i} {ρ}_{i} \vert {V}_{i} \vert}{{\sum }_{i = 1}^{n} {ρ}_{i} \vert {V}_{i} \vert} .$$

The relation (6) will be optimized by an iterative process in the Section below, taking into consideration that the decay heat production rate will continue to slowly decrease over time.

Only in relatively simple cases, exact values for the heat transfer coefficient α can be found by solving the fundamental partial differential equations for the temperature and velocity. An important method for finding the heat transfer coefficients was and still is the experiment. By measuring the heat flow or flux, as well as the wall and fluid temperatures the local or mean heat transfer coefficient can be found. To completely solve the heat transfer problem all the quantities which influence the heat transfer must be varied when these measurements are taken. These quantities include the geometric dimensions (e.g. container length and diameter), the characteristic flow velocity and the properties of the fluid, namely viscosity, density, thermal conductivity and specific heat capacity. To determine the heat transfer coefficient α, we use the mathematical model of heated container (1) and the water temperature data measured inside the container.

Denote b_{HS}=Sα/Cₕₒₘ. Hence

P=Cₕₒₘb_{HS}(T_{steady,hom}−T_{∞}). (8)

Thus for relation (3) we have

$$T ( t ) = \frac{P}{S α} + {T}_{∞} + ( {T}_{0 , water . i n , av} - \frac{P}{S α} - {T}_{∞} ) exp [ - {b}_{HS} \frac{t}{M} ] , \qquad ( 9 )$$

where the coefficient b_{HS} will be calculated by using (9) and the experimentally obtained data of water heated inside the container by minimizing the distance:

$$[ {\sum }_{i = 1}^{N} {( T ( ih ) - {T}_{i h , water . i n , av} )}^{2} ] min , \qquad ( 10 )$$

where
h is a constant time step of measurement of water temperature,
Nh is a time at which a small drop in water temperature is observed due to the reduction in power of used nuclear fuel in the container and
T_{ih,water.in,av} is a averaged water temperature at the time ih detected by the sensors located in center of the container C-30 [° C.].

The Coefficient b_{HS}

Denote \tilde{h}=h/M, where h is a time step of measurement (in seconds) and N is a natural number for which T_{Nh,water.in,av}=T_{steady,water.in,av}.

The stationary point and global minimum of (10), the coefficient b_{HS}, is an unique solution of transcendental equation

$${\sum }_{i = 1}^{N} i exp [ - 2 i {b}_{HS} \tilde{h} ] = {\sum }_{i = 1}^{N} i {β}_{i} exp [ - i {b}_{HS} \tilde{h} ] , \\ where \\ \tilde{h} = \frac{h}{M} , {β}_{i} = \frac{{T}_{steady , water . i n , av} - {T}_{ih , water . i n , av}}{{T}_{steady , water . i n , av} - {T}_{0 , water . i n , av }} , i = 1 , … N . \qquad ( 11 )$$

This equation for calculating b_{HS} was obtained as follows. From the equation (5) for steady state regime we have

$${T}_{steady , water . i n , av} - {T}_{∞} = \frac{P}{S α}$$

and thus for (9) we get

$$T ( t ) = {T}_{steady , water . i n , av} + ( {T}_{0 , water . i n , av} - {T}_{steady , water . i n , av} ) exp [ - {b}_{HS} \frac{t}{M} ] .$$

Now differentiating the left side of (10) where

$$T ( ih ) = {T}_{steady , water . i n , av} + ( {T}_{0 , water . i n , av} - {T}_{steady , water . i n , av} ) exp [ - {b}_{HS} i \tilde{h} ] , \tilde{h} = \frac{h}{M}$$

with respect to the variable b_{HS} and equating this to zero we get

$$- 2 {\sum }_{i = 1}^{N} [ {T}_{ih , water . i n , av} - {T}_{steady , water . i n , av} - ( {T}_{0 , water . i n , av} - {T}_{steady , water . i n , av} ) exp [ - {b}_{HS} i \tilde{h} ] ] ( {T}_{steady , water . i n , av} - {T}_{0 , water . i n , av} ) i \tilde{h} exp [ - {b}_{HS} i \tilde{h} ] = 0.$$

### Hence

$${\sum }_{i = 1}^{N} [ {T}_{ih , water . i n , av} - {T}_{steady , water . i n , av} - ( {T}_{0 , water . i n , av} - {T}_{steady , water . i n , av} ) exp [ - {b}_{HS} i \tilde{h} ] ] i exp [ - {b}_{HS} i \tilde{h} ] = 0$$

and finally, after simple algebraic manipulation we have (11).

Coefficient b_{HS} Optimization Algorithm

We use the b_{HS} coefficient-optimizing algorithm taking into consideration reduction in power of used nuclear fuel in the container.

We apply the following iterative scheme:

$${\sum }_{i = 1}^{N} i exp [ - 2 i {b}_{HS}^{( k )} \tilde{h} ] = {\sum }_{i = 1}^{N} i {β}_{i}^{( k )} exp [ - i {b}_{HS}^{( k )} \tilde{h} ] , \\ where \\ {β}_{i}^{( k )} = \frac{( {T}_{steady , water . i n , av} + {Δ}^{( k - 1 )} ) - {T}_{ih , water . i n , av}}{( {T}_{steady , water . i n , , av} + {Δ}^{( k - 1 )} ) - {T}_{0 , water . i n , av}} , \\ i = 1 , … N , \\ {Δ}^{( 0 )} = 0 , \\ {Δ}^{( k )} = \frac{( {T}_{steady , water . i n , av} - {T}_{0 , water . i n , av} ) exp [ - {b}_{HS}^{( k )} N \tilde{h} ]}{1 - exp [ - {b}_{HS}^{( k )} N \tilde{h} ]} , \\ k = 1 , … \qquad ( 12 )$$

To solve the equation (12) we use the mathematical software package.

An iterative process is finished when a stopping criterion is achieved,

|b_{HS}^{(k)}−b_{HS}^{(k-1)}|≦ε(ε=10⁻³, for example).

Thus, the optimized relation (8) for residual power of used nuclear fuel is

P=Cₕₒₘb_{HS}^{(k)}(T_{steady,hom}+Δ^{(k-1)}−T_{∞}). (13)

Quality of Optimization of b_{HS}^{(k)}

The quality of optimization Λ^{(k)} of the coefficient b_{HS}^{(k)} (i.e. of k-th iteration) can be determined from the relation

$$\begin{matrix}{Λ}^{( k )} = {T}_{Nh , water . i n , av} - {T}^{( k )} ( Nh ) = \{ ( {T}_{steady , water . i n , av} + {Δ}^{( k - 1 )} - {T}_{0 , water . i n , av} ) exp [ - {b}_{HS}^{( k )} N \tilde{h} ] \} - {Δ}^{( k - 1 )} , \\ where \\ {T}^{( k )} ( t ) = {T}_{steady , water . i n , av} + {Δ}^{( k - 1 )} + ( {T}_{0 , water . i n , av} - {T}_{steady , water . i n , av} - {Δ}^{( k - 1 )} ) exp [ - {b}_{HS}^{( k )} \frac{t}{M} ] , & \\ k = 1 , 2 , … & \end{matrix}$$

### Hence

T^{(k)}(∞)=T_{steady,water.in,av}+Δ^{(k-1)},k=1,2, . . .

A smaller value of Λ^{(k)} implies a more accurate approximation of b_{HS}.

Now the proposed method will be illustrated and validated by using the real data.

Proposed Method Application for the Container with UNF.

### The First Experiment

Residual power calculated by the SCALE 6 system: P_{SCALE6}=17309 [W].

The input data are the following:
h=7200
\tilde{h}=7200/84600
N=40
T_{0,water.in,av}=63.3
T_{∞}=21
T_{water.in,av}=71 [symbol] C_{w}=4193
T_{steady,water.in,av}=73.8
T_{steady,coat.out,av}=50.34.

The Table I contains the key values for determining the coefficients b_{HS}^{(k)} and Δ^{(k)} for (13).

Using the iterative scheme as is presented in the Section, we obtain
b_{HS}⁽¹⁾=1.051, Δ⁽¹⁾=0.301, Λ⁽¹⁾=0.293
b_{HS}⁽²⁾=0.983, Δ⁽²⁾=0.382, Λ⁽²⁾=0.078
b_{HS}⁽³⁾=0.966, Δ⁽³⁾=0.407, Λ⁽³⁾=0.023
b_{HS}⁽⁴⁾=0.960, Δ⁽⁴⁾=0.414, Λ⁽⁴⁾=0.007
b_{HS}⁽⁵⁾=0.959, Δ⁽⁵⁾=0.417, Λ⁽⁵⁾=1.452×10⁻¹⁰
   and from (4) we get Cₕₒₘ≐594.35.

Further, from (7) we have

$${T}_{steady , hom} = \frac{73.8 \times 3790 + 50.34 \times 67300}{3790 + 67300} = 51.591 [ ° C . ] .$$

Substituting these values into (13) (with k=5) we obtain

P=Cₕₒₘb_{HS}⁽⁵⁾(T_{steady,hom}+Δ⁽⁴⁾−T_{∞})=594.35×0.959×(51.591+0.414−21)≐17672[W].

Proposed Method Application for the Container with UNF.

### The Second Experiment

Residual power calculated by the SCALE 6 system: P_{SCALE6}=16355 [W].

The input data are the following:
h=7200
\tilde{h}=7200/84600
N=59
T_{0,water.in,av}=44.7
T_{∞}=18
T_{water.in,av}=65 [symbol] C_{w}=4190
T_{steady,water.in,av}=71.8
T_{steady,coat.out,av}=50.26.

In the Table II are the values of water temperature for determining the coefficients b_{HS}^{(k)} and Δ^{(k)} for (13).

Using these values for the iterative procedure we get
b_{HS}⁽¹⁾=0.826, Δ⁽¹⁾=0.434, Λ⁽¹⁾=0.427
b_{HS}⁽²⁾=0.793, Δ⁽²⁾=0.514, Λ⁽²⁾=−5.273×10⁻¹¹
b_{HS}⁽³⁾=0.786, Δ⁽³⁾=0.534, Λ⁽³⁾=−1.099×10⁻¹⁰
b_{HS}⁽⁴⁾=0.784, Δ⁽⁴⁾=0.538, Λ⁽⁴⁾=4.102×10⁻¹⁰.

Similarly as for the first measurement we obtain Cₕₒₘ≐594.17 and from (7) we have

$${T}_{steady , hom} = \frac{71.8 \times 3790 + 50.26 \times 67300}{3790 - 67300} = 51.4083556 [ ° C . ] .$$

Substituting these values into (13) (with k=4) we obtain

P=(Cₕₒₘb_{HS}⁽⁴⁾(T_{steady,hom}+Δ⁽³⁾−T_{∞})=594.17×0.784×(51.41+0.534−18)=15812[W].

### CONCLUSIONS

The proposed method application leads to the good results. The percentage difference between the results achieved by the SCALE 6 system and our method based on the heat transfer analysis is

$$\frac{{P}_{SCALE 6} - P}{{P}_{SCALE 6}} \cdot 100 \% = \frac{17309 - 17672}{17309} \cdot 100 \% = - 2.09 \%$$

for the first measurement and

$$\frac{{P}_{SCALE 6} - P}{{P}_{SCALE 6}} \cdot 100 \% = \frac{16355 - 15812}{16355} \cdot 100 \% = 3.3 \%$$

for the second one, which is negligible for this type of calculation and is within the range of measurement uncertainty (3-5%). Since an exact mathematical modeling of the thermal processes in the system container plus water plus used nuclear fuel with non-uniform burnup distributions is impossible, inter alia some of the parameters of the model may be determined experimentally only (for instance a heat transfer coefficient α).

TABLE I
The values T_{ih, water. in, av}, i = 0, . . . , N. First experiment

| | | | | | | | | | |
|---|---|---|---|---|---|---|---|---|---|
| i | 0 | 1 | 2 | 3 | 4 | 5 | 6 | 7 | 8 |
| T_{ih, water. in, av} | 63.3 | 64.2 | 64.9 | 65.6 | 66.2 | 66.7 | 67.2 | 67.7 | 68.1 |
| i | 9 | 10 | 11 | 12 | 13 | 14 | 15 | 16 | 17 |
| T_{ih, water. in, av} | 68.5 | 68.9 | 69.4 | 69.8 | 70.2 | 70.6 | 71.0 | 71.3 | 71.6 |
| i | 18 | 19 | 20 | 21 | 22 | 23 | 24 | 25 | 26 |
| T_{ih, water. in, av} | 71.9 | 72.1 | 72.4 | 72.6 | 72.8 | 73.0 | 73.1 | 73.2 | 73.2 |
| i | 27 | 28 | 29 | 30 | 31 | 32 | 33 | 34 | 35 |
| T_{ih, water. in, av} | 73.3 | 73.3 | 73.3 | 73.4 | 73.5 | 73.5 | 73.6 | 73.6 | 73.6 |
| i | 36 | 37 | 38 | 39 | 40 | | | | |
| T_{ih, water. in, av} | 73.7 | 73.7 | 73.7 | 73.7 | 73.8 | | | | |

TABLE II
The values T_{ih, water. in, av}, i = 0, . . . , N. Second experiment

| | | | | | | | | | |
|---|---|---|---|---|---|---|---|---|---|
| i | 0 | 1 | 2 | 3 | 4 | 5 | 6 | 7 | 8 |
| T_{ih, water. in, av} | 44.7 | 46.8 | 48.7 | 50.4 | 51.9 | 53.4 | 54.7 | 55.9 | 57.0 |
| i | 9 | 10 | 11 | 12 | 13 | 14 | 15 | 16 | 17 |
| T_{ih, water. in, av} | 58.1 | 58.9 | 59.9 | 60.7 | 61.5 | 62.1 | 62.8 | 63.4 | 63.9 |
| i | 18 | 19 | 20 | 21 | 22 | 23 | 24 | 25 | 26 |
| T_{ih, water. in, av} | 64.4 | 64.9 | 65.3 | 65.7 | 66.1 | 66.4 | 66.7 | 67.0 | 67.3 |
| i | 27 | 28 | 29 | 30 | 31 | 32 | 33 | 34 | 35 |
| T_{ih, water. in, av} | 67.5 | 67.7 | 68.0 | 68.1 | 68.3 | 68.5 | 68.6 | 68.8 | 68.9 |
| i | 36 | 37 | 38 | 39 | 40 | 41 | 42 | 43 | 44 |
| T_{ih, water. in, av} | 69.0 | 69.1 | 69.2 | 69.3 | 69.4 | 69.5 | 69.6 | 69.7 | 69.7 |
| i | 45 | 46 | 47 | 48 | 49 | 50 | 51 | 52 | 53 |
| T_{ih, water. in, av} | 69.8 | 70.0 | 70.1 | 70.3 | 70.5 | 70.7 | 70.8 | 71.0 | 71.1 |
| i | 54 | 55 | 56 | 57 | 58 | 59 | | | |
| T_{ih, water. in, av} | 71.2 | 71.4 | 71.5 | 71.6 | 71.7 | 71.8 | | | |

Having described our invention, we claim:

1. a heat transfer approach to the calculation of residual power of used nuclear fuel comprising
a. the idea of examining the relationship between the temperature dynamics of the water in the container and the temperature of outer walls of the container and residual power of used nuclear fuel;
b. a mathematical model (1) for heat transfer through the wall of homogenized transport container with used nuclear fuel inside;
c. an analytic/experimental method for determination of coefficient b_{HS}=Sα/Cₕₒₘ.

2. a heat transfer approach to the calculation of residual power of used nuclear fuel as recited in claim 1, further comprising the application to all types of transport containers intended for used nuclear fuel.
